(19) United States
(12) Patent Application Publication
(10) Pub. No.: US 2020/0221636 A1
(43) Pub. Date: Jul. 16, 2020

(54) A Harvesting Method and Apparatus

(71) Applicant: CNH Industrial America LLC, New Holland, PA (US)

(72) Inventors: Joachim Boydens, Zedelgem (BE); Bart M.A. Missotten, Herent (BE); Didier Verhaeghe, Ieper (BE)

(21) Appl. No.: 16/611,789

(22) PCT Filed: May 8, 2018
(86) PCT No.: PCT/EP2018/061893

§ 371 Date: Nov. 7, 2019

(30) Foreign Application Priority Data
May 9, 2017 (BE) 2017/5334

(51) Int. Cl. A01D 41/127; G06Q 50/02; G06Q 10/04; A01F 15/08

(52) U.S. Cl. CPC A01D 41/127; A01F 15/08; G06Q 10/04; G06Q 50/02

(57) ABSTRACT

A harvesting method includes the steps of operating a moveable harvesting machine in one or more fields to harvest plant matter and produce a secondarily processable harvest product for subsequent processing using secondary processing machinery; and while operating the harvesting machine to produce the secondarily processable harvest product, recording data that includes information on one or more characteristics of the secondarily processable harvest product. The method further includes transferring the recorded data from the harvesting machine to an external data store; causing moveable secondary processing machinery to retrieve at least some data on the secondarily processable harvest product from the data store; and controlling one or more controllable parameters of the secondary processing machinery based on the retrieved data during operation of the secondary processing machinery to process the secondarily processable harvest product.

### BACKGROUND OF THE INVENTION

The invention relates to a farming method and apparatus. In particular the invention relates to a method of improving the efficiency of harvesting operations, and apparatus for carrying out the method.

It is the norm in arable agriculture to make use of numerous moveable machines to perform tasks during growing and harvesting seasons. In recent decades the ability of such machines to record data and information about the work completed and conditions encountered while completing tasks has increased dramatically. It moreover is known to transfer data from one machine to another in order to improve the efficiency of agricultural production.

Thus for example it is known for a harvesting machine such as a combine harvester to generate a yield map of a field during harvesting. This identifies the differences in productivity of differing parts of the field, and may be used subsequently to control e.g. a crop spraying machine such that expensive agrochemicals are dosed appropriately in the field according to need, and are not wasted on parts of the field that inherently yield highly.

Hitherto however the use of such data has concentrated on the single goal of increasing yields. In the case of baling of harvest products however a high yield may be problematic. The invention seeks to address problems of high yields in such situations.

In more detail, various mobile harvesting machines such as combine harvesters, forage harvesters and mowers produce as either a primary or secondary product harvest matter that is intended to be baled and sold.

Such harvest matter may include, but is not limited to, stalks, stems, leaves, straw and similar parts of plants. The harvest matter typically is left in fields in the form of swaths or windrows, i.e. elongate rows of the products in question that are heaped in the transverse centre and tend to flatten at the respective transverse edges. Although according to some definitions there are differences between e.g. swaths and windrows, except where the context requires these terms are used interchangeably herein.

Each swath usually extends in as straight a line as possible for almost the entire length of a field, or along lines that are equidistant from the periphery of the field or from contours in the field. Typically a field that has undergone harvesting contains many, essentially mutually parallel, swaths.

It is known to employ a baling machine to form the swaths of harvest matter into bales. In the majority of cases the baler is neither autonomous nor self-powered, and instead is towed behind an agricultural tractor from which it derives rotary power to drive its pickup components and internal machinery.

The invention is applicable in the use of balers to bale stalks or other plant parts as deposited in swaths or in windrows created by a primary operation such as harvesting or a secondary operation such as raking, tedding or hay bobbing (such operations being familiar to the person of skill in the art).

Balers fall in to several categories. The most common types presently in use are those for creating so-called “round” bales, usually of hay or straw (that are approximately cylindrical); and those for creating so-called “rectangular” or “square” bales (that are cuboidal). Each bale type is associated with particular storage and handling characteristics.

Among rectangular balers the most common types produce either “large rectangular bales” or “midi rectangular bales”. As the names imply, the former are larger than the latter.

Regardless of the exact type, in use a baler is hitched to the rear of a tractor and the power take-off (PTO) shaft of the tractor connected to provide rotary drive to the baler. The PTO shaft rotates at a speed determined by the settings of the tractor engine and in some cases certain other variable parameters that are settable e.g. by the tractor driver or as a result of automatic or semi-automatic control actions initiated in the tractor or baler such as when one or more sensors produces a particular output, class of output, value or range. Typically the PTO shaft includes a universal joint or similar flexible drive-transferring arrangement, with the result that the connection to the baler does not have to be directly in line with the PTO connection on the tractor, and instead may be offset laterally from it.

The PTO shaft provides rotary drive for the various parts of the baler that move to cause ingestion and baling of stalks. U.S. Pat. No. 4,433,533-A includes an explanation of the operation of a round baler. An example of rectangular baler operation is described in FR-2684517-A.

In use of a tractor-baler combination the tractor tows the baler along each swath in turn, from one end of a field to the other, with the pick-up ingesting the harvest products requiring baling. This causes removal of the harvest matter forming the swaths as the bales are formed. At the end of each swath that has been ingested in this way and formed into bales the tractor-baler combination turns in the field headland and passes in the reverse direction along the filed to cause baling of the harvest products of the next swath in turn to be baled.

The capacity of the pick-up to gather harvest matter, and the capacity of the baler to process gathered harvest matter into bales, will be limited as a result of aspects of the design of the baler. A problem in use of many baler designs arises therefore when the feed rate of harvest products from the swaths exceeds the pick-up and/or bale-forming capacity of the baler.

In such situations the baler may become blocked or plugged with an excess of harvest matter. This is often a particularly inconvenient occurrence since it may be necessary partly or indeed largely to dismantle the baler in order to clear the blockage, that may consist of very tightly packed and intermingled plant parts. Such blockage clearing work may occupy a tractor driver for an hour or more, with concomitant adverse effects on the baling yield, efficiency and the ability of a particular tractor-baler combination to finish baling a field of swaths within a desired time period.

Some designs of baler include at locations in or near the path of harvest matter inside the baler one or more shear bolts the aim of which is to prevent damage to the baler in the event of severe blocking as outlined above. The shear bolts are designed to shear when the loading-induced shear or tensile forces experienced by the shear bolts exceed design limits, leading to breaking. This may in turn e.g. disconnect the rotary drive from the baler, thereby preventing or minimising damage to interior parts of the baler caused by overloading.

The operator of a tractor-baler combination may carry one or more replacement shear bolts that allow repair of the baler following breaking of an installed shear bolt as outlined; but this too may be a complex and time-consuming process. Any shear bolt replacement is likely additionally to be associated with partial dismantling of the baler both to access the shear bolt and also to clear any jammed harvest products.

A further problem is that the operator may not have a correct replacement shear bolt at the time of shear bolt breaking. This could give rise to a prolonged period of disablement of the baler, or perhaps a repair using inappropriate components. The latter could adversely affect the future performance or safety of the baler.

It is desirable to minimise the risk of overloading of the baler as may arise from an excessive feed rate of harvest products into the baler.

### SUMMARY OF THE INVENTION

According to the invention in a first aspect there is provided a harvesting method comprising the steps of (a) operating a moveable harvesting machine in one or more fields to harvest plant matter and produce a secondarily processable harvest product for subsequent processing using secondary processing machinery; (b) while operating the harvesting machine to produce the secondarily processable harvest product, recording data that is capable of giving rise to or including information on one or more characteristics of the secondarily processable harvest product; (c) transmitting or transferring the recorded data from the harvesting machine to an external data store; (d) causing moveable secondary processing machinery to retrieve at least some data on the secondarily processable harvest product from the data store; and (e) controlling one or more controllable parameters of the secondary processing machinery based on the retrieved data during operation of the secondary processing machinery to process the secondarily processable harvest product.

An advantage of the method of the invention is that certain controllable parameters of secondary processing machinery such as but not limited to a baler may be adjusted in dependence on the recorded and transmitted data in order to minimise or eliminate the risk of overloading of the secondary processing machinery in ways as exemplified above. Thus if for example the recorded data indicate e.g. the production of a large amount of secondarily processable harvest product in a particular area of a field the speed of forward motion of secondary processing machinery, or another parameter related to the rate at which the secondary processing machinery is required to process matter, may be reduced in order to avoid overloading of the secondary processing machinery.

For the avoidance of doubt the method of the invention may as needed include one or more intermediate operations, such as tedding, raking or bobbing, that is carried out on the secondarily processable harvest product between operation of the harvesting machine and operation of the secondary processing machinery.

Non-limiting examples of secondarily processable harvest products to which the invention pertains include straw, grass, hay, stalks, other forms of silage and other non-grain plant parts.

As referred to herein a secondary process is one, such as but not limited to baling, that is carried out on the secondarily processable harvest products subsequent to the production of those products. As is well known, operations such as baling may take place some days or even weeks after operation of a harvesting machine to produce material that is to be baled. References to secondary processing of products (and derivative terms) include situations in which somewhat lengthy time gaps as outlined occur between the steps of the method.

Preferably as indicated the harvesting machine is a combine harvester, or may be a forage harvester or mower; and the secondary processing machinery is or includes a tractor-baler combination in which a baler is towed behind a tractor. However other forms of harvesting machine and secondary processing machinery alternatively may be contemplated within the scope of the invention. Thus, stated more broadly, the invention may include a tractor-trailer combination in which a trailer is towed behind a tractor. Such a trailer may be for example a rake, tedder, haybob or any of a range of other secondary processing machines.

Conceivably therefore the secondary processing machinery could itself be e.g. a rake, tedder or haybob the capacity of which to process harvest products may be capacity-limited. When the secondary processing machinery however is or includes a baler, preferably the method includes the step of (e1) operating the tractor-baler combination to bale secondarily processable harvest product.

In preferred embodiments of the invention the recorded data include information characteristic of one or more of the position, speed, feed rate, grain yield and biomass parameters influencing the harvesting machine at one or more time points during the said operation of the harvesting machine. Such data may usefully be employed to control the parameters of the secondary processing machinery in a manner that meets the aims of the invention.

“Biomass parameters” include but are not limited to data on the density, mass, moisture content as produced, predicted future moisture content, dust content and/or optical characteristics of the secondarily processable harvest products.

Additionally or alternatively the recorded data include information on halting of the harvesting machine during production of secondarily processable harvest product. Such data may be of particular importance because the halting of a harvesting machine such as a combine harvester or forage harvester during harvesting operations may result in heaping of the secondarily processable harvest products. This in turn causes an increase in the federate of such products into a secondary processing machine such as a baler unless steps are taken to prevent this.

The invention beneficially permits appropriate remedial or preventative control actions to be taken during operation of the secondary processing machinery. Such actions may include e.g. slowing the forward movement of the secondary processing machinery; adjusting the position of (for example raising or lowering) a pick-up of such machinery; and/or adjusting the operational speed of internal parts of the secondary processing machinery.

In more detail preferably the method of the invention includes the step of deriving from the recorded data, using one or more processing devices of or operatively connected to the secondary processing machinery, one or more of a predicted feed rate of secondarily processable harvest products to the secondary processing machinery; and a maximum speed of movement of the secondary processing machinery during processing of the secondarily processable harvest product.

Optionally the method of the invention may include the step of deriving from the recorded data, using one or more processing devices of or operatively connected to the secondary processing machinery, a correlation between (a) the rate of production of secondarily processable harvest products during operation of the harvesting machine; and (b) a feed rate of the secondarily processable harvest products to the secondary processing machinery during operation of the secondary processing machinery to process the secondarily processable harvest product.

Such a correlation may be useful for example in establishing predictive relationships between secondarily processable harvest product production on the one hand and the resource or time allocation needed to effect secondary processing of it on the other. This may be beneficial for instance in determining the number of secondary processing machines required to effect the secondary processing needed.

The processing device(s) referred to above may be, or may include, a processor forming part of or operatively connected to a tractor that tows a baler during a baling operation; a processor that is part of or operatively connected to a baler of a tractor-baler combination; or a remote processor to which the secondary processing machinery is operatively connected. Such connection may be effected wirelessly using a range of protocols as are known to the person of skill in the art.

In a particularly preferred embodiment of the method of the invention the external data store is or includes a “cloud”-based data store.

The term “cloud” as used herein is a reference to remote, typically shared, internet-connected server capacity that may be connected to using e.g. mobile data communication protocols as are known to the person of skill in the art. Derivative terms are to be construed accordingly.

According to a second aspect of the invention there is provided apparatus, for carrying out a method according to the invention as defined herein, including a moveable harvesting machine that is capable of (a) harvesting plant matter and producing a secondarily processable harvest product for subsequent processing using secondary processing machinery; (b) while producing the secondarily processable harvest product, recording data that is capable of giving rise to or including information on one or more characteristics of the secondarily processable harvest product; and (c) transmitting the recorded data from the harvesting machine to an external data store; an external data store; and secondary processing machinery that is capable of (d) retrieving at least some data on the secondarily processable harvest product from the data store; and (e) adjusting one or more controllable parameters of the secondary processing machinery based on the retrieved data during operation of the secondary processing machinery to process the secondarily processable harvest product.

Advantages of the apparatus aspect of the invention are analogous to those inuring to the method as defied hereinabove.

Conveniently the harvesting machine is a combine harvester, forage harvester or mower and the secondary processing machinery is or includes a tractor-baler combination in which a baler is towed behind a tractor.

In conformity with the method of the invention preferably the external data store is or includes a “cloud”-based data store, although other forms of external data store also are possible.

Desirably the harvesting machine includes one or more transmitters of the recorded data and wherein the secondary processing machinery includes one or more receivers of data that is retrieved from the external data store. Such features permit the ready embodiment of aspects of the invention in the harvesting machine and secondary processing machinery.

### BRIEF DESCRIPTION OF THE DRAWING

There now follows a description of preferred embodiments of the invention, by way of non-limiting example, with reference being made to the accompanying FIGURE which shows the principles of the method of the invention and apparatus that may be employed in operation of the method.

### DETAILED DESCRIPTION OF THE DRAWING

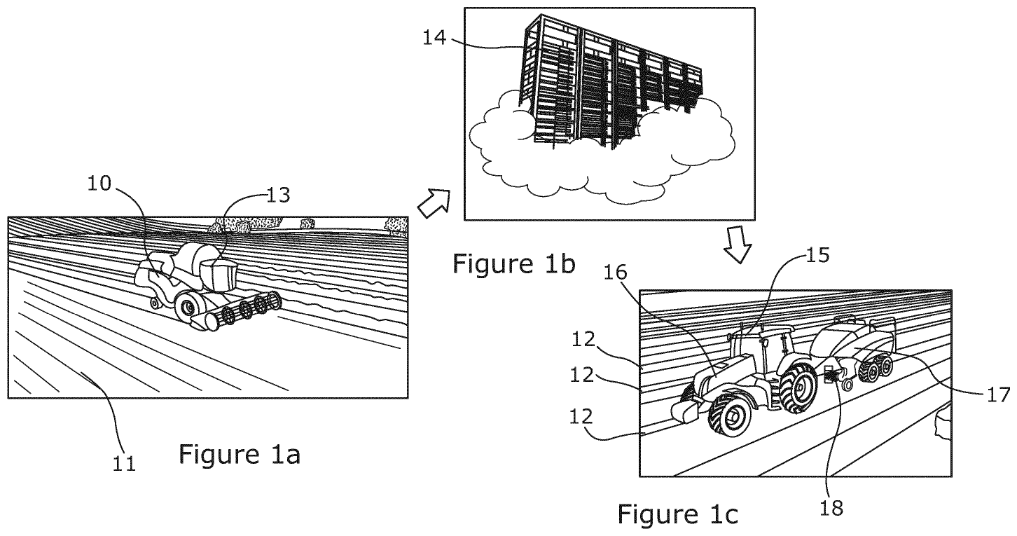

Referring to FIG. 1 there is shown in FIG. 1a a moveable harvesting machine in the form of a combine harvester 10 operating in a field 11 to harvest plant matter. In FIG. 1 the combine harvester 10 is in use to harvest grains, as a primary product, from grain plants but in other embodiments of the invention a wide range of other types of plant matter could be produced.

As is well known during the harvesting of grains a combine harvester produces, and ejects via a rear chute, a secondarily processable harvest product in the form of straw, that is a valuable secondary crop. Straw is baled into bales for sale to e.g. animal owners and others.

Other secondarily processable harvest products may be produced as a result of other types of harvesting operations. As examples the use of mowers and forage harvesters generates forage products such as hay and silage. Such products while the primary output of the harvesting machines indicated nonetheless must undergo secondary processing in order to form them into bales. Hence the outputs of mowers and forage harvesters also may be termed “secondarily processable harvest products”.

As noted the secondarily processable harvest products are left in fields in swaths or windrows 12 to await baling or other secondary processing.

The combine harvester 10 includes one or more sensors or other data generating apparatuses represented schematically by numeral 13 that generate data on the secondarily processable harvest products. The combine harvester 10 is capable of transmitting the data as signals (e.g. electrical signals). This may be achieved through operation of features of the sensor(s) 13 or through operation of further sub-components of the combine harvester 10 such as processing apparatuses of various kinds that will be familiar to the person of skill in the art.

The data that the combine harvester creates on the secondarily processable harvest products may be of the kinds discussed herein.

As signified schematically by FIG. 1b and the arrow connecting FIGS. 1a and 1b the combine harvester 10 is capable of transmitting data on the secondarily processable harvest products to an external data store that in the preferred embodiment illustrated is a cloud server 14. In other embodiments of the invention however the external data store may be, or may include, a data medium such as but not limited to a flash memory device, storage disk or similar; or it may be or may include a dedicated server such as a server in or connected to the headquarters of a farming company. Other forms of external data store are also possible within the scope of the invention. Such forms of external data store may be temporarily insertable into read/write machinery forming part of the harvesting machine and into such machinery forming part of the secondary processing machinery. For the avoidance of doubt, the method of the invention includes the step of effecting transmission or transfer of the data generated by the harvesting machine on the secondarily processable harvest products to the external data store.

In a subsequent aspect of the method secondary processing machinery, that as illustrated in FIG. 1b in preferred embodiments of the invention is a combination of a tractor 16 towing a baler 17, is employed to carry out secondary processing of the secondarily processable harvest products. As implied and as stated herein, in the preferred embodiment of the invention the secondary processing involves baling of the secondarily processable harvest product. In other embodiments of the invention however other secondary processes may be carried out either as alternatives or as adjuncts to the baling process described.

During operation of the baler 17 the tractor 16 and/or the baler 17 as schematically indicated in the FIGURE accesses the data previously transferred to the external data store and makes use of it in the control of the tractor-baler combination 16, 17. To this end the tractor 16 and/or the baler 17 may include e.g. an antenna indicated schematically by numeral 15 that is capable of receiving the data in a transmitted form.

Examples of how the data may be used are described hereinabove. One important example of such use is controlling of e.g. the forward speed of the tractor-baler combination 16, 17 in dependence on data on the quantity, mass and/or density of straw or other secondarily processable harvest products in the swaths 12. As explained, at times corresponding to a high feed rate of straw into the baler 17 the forward motion of the tractor-baler combination may be slowed in order to avoid any of the known forms of overloading of the baler 17 as are summarised above.

Additionally or alternatively a parameter of the pick-up 18 of the baler 17 may be adjusted to moderate the feed rate at times of high rates of ingestion.

Similarly the tractor 16 may be controlled to speed up when the feed rate of straw into the baler reduces. This advantageously assists to ensure good bale quality and high baling efficiency.

As explained a particularly useful form of data generated and transmitted or transferred by the harvesting machine relates to times of halting. At such times the straw or other secondarily processable harvest product may become heaped or otherwise of abnormally high density in the swaths 12. Knowledge of locations where such heaps arise can beneficially help to avoid a common cause of baler overloading. Use of the data in accordance with the invention during the baling operation is particularly useful in this regard.

To this end the invention may involve the generation of commands that effect control of one or more parameters of operation of the tractor 16 and/or the baler 17 to minimise the likelihood of an overload condition arising. Such parameters may be as described herein. The commands may result in controlling of e.g. the settings of transmission and fuelling components or sub-systems of the tractor 16, and/or settings of the baler 17.

Additionally or alternatively as mentioned herein it is possible, within the method of the invention, to determine (e.g. by calculation or any of a range of other techniques such as but not limited to curve-fitting or semblance analysis) a correlation between (a) the rate of production of secondarily processable harvest products during operation of the harvesting machine; and (b) a feed rate of the secondarily processable harvest products to the secondary processing machinery during operation of the secondary processing machinery to process the secondarily processable harvest products. This may be particularly useful when it is not possible for the tractor 16 or the baler 17 to generate field data in real time during baling.

The correlation may include maximum feedrate information and/or maximum speed information as mentioned herein. Such information may be used e.g. to sound an audible warning and/or display a visible warning in the operator's cab of the tractor 16 or effect a control action such as slowing the tractor 16 or limiting its maximum speed. The latter type of control action may be effected through the generation of commands that influence the fuelling and transmission ratio controls of the tractor 16.

Typically the combine harvester 10, tractor 16 and baler 17 are in terms of primary characteristics conventional. However as indicated the combine harvester (or other harvesting machine) includes features, apparatus and/or sub-systems that collate the indicated data and transmit or transfer the data to the external data store.

Similarly the secondary processing machinery when embodied as a tractor-baler combination 16, 17 may include numerous conventional aspects. However one or both of the tractor 16 and baler 17 is equipped with data transfer (and especially data receiving) apparatus, components or sub-systems that may be wireless receivers, read/write machinery or combinations of such apparatuses.

The tractor 16 and baler 17 preferably are connected one to the other not only by a physical connection such as a drawbar and power take-off (PTO) shaft that are not visible in the FIGURES; but also electronically such that data and commands may be shared between the two elements of the secondary processing machinery. Such electronic connection may be wired or wireless. In the latter case the connection may be based on a variety of physical phenomena as are known in data communications technology.

The invention represents a considerable advance in the reliability and efficiency of secondary processing operations in arable agriculture.

The listing or discussion of an apparently prior-published document in this specification should not necessarily be taken as an acknowledgement that the document is part of the state of the art or is common general knowledge.

Preferences and options for a given aspect, feature or parameter of the invention should, unless the context indicates otherwise, be regarded as having been disclosed in combination with any and all preferences and options for all other aspects, features and parameters of the invention.

1. A harvesting method comprising steps of:
operating a moveable harvesting machine in one or more fields to harvest plant matter and produce a secondarily processable harvest product for subsequent processing using secondary processing machinery;
while operating the harvesting machine to produce the secondarily processable harvest product, recording data that includes information on one or more characteristics of the secondarily processable harvest product;
transferring the recorded data from the harvesting machine to an external data store;
causing moveable secondary processing machinery to retrieve at least some data on the secondarily processable harvest product from the data store; and
controlling one or more controllable parameters of the secondary processing machinery based on the retrieved data during operation of the secondary processing machinery to process the secondarily processable harvest product.

2. The method according to claim 1, wherein the harvesting machine is a combine harvester, forage harvester or mower and the secondary processing machinery includes a tractor-baler combination in which a baler is towed behind a tractor or a tractor-trailer combination in which a trailer is towed behind a tractor.

3. The method according to claim 2, further including a step of operating the tractor-baler combination to bale secondarily processable harvest product.

4. The method according to claim 1, wherein the recorded data include information characteristic of one or more of a position, speed, feedrate, grain yield and biomass parameters of the harvesting machine at one or more time points during operation of the harvesting machine.

5. The method according to claim 1, wherein the recorded data include information on halting of the harvesting machine during production of secondarily processable harvest product.

6. The method according to claim 1, further including a step of deriving from the recorded data, using one or more processing devices of or operatively connected to the secondary processing machinery, one or more of a predicted feedrate of secondarily processable harvest products to the secondary processing machinery; and a maximum speed of movement of the secondary processing machinery during processing of the secondary product.

7. The method according to claim 1, further including a step of deriving from the recorded data, using one or more processing devices of or operatively connected to the secondary processing machinery, a correlation between a rate of production of secondarily processable harvest products during operation of the harvesting machine; and a feedrate of the secondarily processable harvest products to the secondary processing machinery during operation of the secondary processing machinery to process the secondarily processable harvest product.

8. The method according to claim 1, wherein the external data store is or includes a “cloud”-based data store.

9. A system comprising:
an external data store;
a moveable harvesting machine configured for:
harvesting plant matter;
producing a secondarily processable harvest product for subsequent processing using secondary processing machinery;
while producing the secondarily processable harvest product, recording data including information on one or more characteristics of the secondarily processable harvest product; and
transmitting the recorded data from the harvesting machine to the external data store; and
secondary processing machinery configured for:
retrieving at least some data on the secondarily processable harvest product from the data store; and
adjusting one or more controllable parameters of the secondary processing machinery based on the retrieved data during operation of the secondary processing machinery to process the secondarily processable harvest product.

10. The apparatus according to claim 9, wherein the harvesting machine is a combine harvester, forage harvester or mower and the secondary processing machinery is or includes a tractor-baler combination in which a baler is towed behind a tractor.

11. The apparatus according to claim 9, wherein the external data store is or includes a “cloud”-based data store.

12. The apparatus according to claim 9, wherein the harvesting machine includes one or more transmitters of the recorded data and wherein the secondary processing machinery includes one or more receivers of data that is retrieved from the external data store.
